(19) United States
(12) Patent Application Publication
(10) Pub. No.: US 2025/0078491 A1
(43) Pub. Date: Mar. 6, 2025

(54) HIGH-PERFORMANCE OBJECT DETECTION SYSTEM USING HDR IMAGES OBTAINED FROM LDR CAMERAS IN AUTONOMOUS VEHICLES

(71) Applicant: ORTA DOGU TEKNIK UNIVERSITESI, Ankara (TR)

(72) Inventors: Abdullah Aydin ALATAN, Ankara (TR); Ismail Hakki KOCDEMIR, Ankara (TR); Sinan KALKAN, Ankara (TR); Ahmet Oguz AKYUZ, Ankara (TR); Alper KOZ, Ankara (TR); Alan CHALMERS, Ankara (TR)

(73) Assignee: ORTA DOGU TEKNIK UNIVERSITESI, Ankara (TR)

(21) Appl. No.: 18/725,867

(22) PCT Filed: Dec. 28, 2022
(86) PCT No.: PCT/TR2022/051657

§ 371 Date: Jul. 1, 2024

(30) Foreign Application Priority Data
Dec. 29, 2021 (TR) 2021/021665

(51) Int. Cl. G06V 10/70; G06T 5/50; G06T 5/92; G06V 10/32

(52) U.S. Cl. CPC G06V 10/87; G06T 5/50; G06T 5/92; G06V 10/32; G06T 2207/10144; G06T 2207/20081; G06T 2207/20212

(57) ABSTRACT

A high-performance object detection system using HDR images obtained from LDR cameras, which allows for the separation and recognition of detected objects in images under high illumination difference conditions (tunnels, sunrise or sunset, etc.) and prevents autonomous vehicles from causing undesired accidents is provided.

### CROSS REFERENCE TO RELATED APPLICATIONS

This application is a 371 National Stage entry of PCT/TR2022/051657 filed Dec. 28, 2022 based upon and claims priority to Turkish Patent Application 2021/021665 filed on Dec. 29, 2021, the entire contents of which are incorporated herein by reference.

### TECHNICAL FIELD

The present invention relates to a high-performance object detection system in autonomous vehicles using HDR (High Dynamic Range) images obtained from LDR (Low Dynamic Range) cameras.

### BACKGROUND

Image processing and enhancement, which is used to obtain information about the nature of an object, is one of the main tools used for object identification [1], tracking [2], detection [3] and classification [4]. Image processing methods are frequently used in many fields such as military industry, security, medicine, robotics, physics, biomedical and satellite images. The presence of the target object to be tracked in a scene with a high difference in illumination is one of the most important problems that complicates object tracking and analysis. Different methods have been developed to solve this problem and to successfully track the object and reconstruct the 3D structure of the scene [5,6,7].

It is expected that autonomous vehicles will become widespread in the next 10 years and will significantly reduce human use. The ability of autonomous vehicles to make the right decisions at critical moments can only be possible with the transmission of images unaffected by external weather conditions and light changes to automatic analysis units by all sensors and especially cameras providing visual data. The fact that High Dynamic Range (HDR) sensors and cameras are expensive for consumers requires that the same quality images are obtained with economical Low Dynamic Range (LDR) cameras [8,9,10,11,12].

The following documents were found in the literature review showing the state of the art.

U.S. Patent No. U.S. Pat. No. 8,811,811 mentions a system for generating an output image. In this system, the first camera of a camera pair is configured to record the first part of a scene to obtain the first recorded image. The second camera of the camera pair is configured to record a second part of the scene to obtain a second recorded image. Also, a central camera is configured to record another part of the scene to obtain a central image. A processor is configured to generate the output image. The initial brightness range of the first camera of each camera pair is different from the central camera brightness range and differs from the first brightness range of the first camera of any other camera pair of one or more camera pairs.

In U.S. Patent No. U.S. Pat. No. 9,420,200 B2, high dynamic range 3D images are generated with relatively narrow dynamic range image sensors. The input frames of different views can be adjusted to different exposure settings. Pixels in input frames can be normalized to a common range of brightness levels. The difference between normalized pixels in the input frames can be calculated and interpolated. Pixels in different input frames can be shifted to or remain in a common frame of reference. The pre-normalized brightness levels of the pixels can be used to generate high dynamic range pixels that form one, two or more output frames of different views. Also, a modulated synopter with electronic mirrors is combined with a stereoscopic camera to capture monoscopic HDR, variable monoscopic HDR and stereoscopic LDR images or stereoscopic HDR images.

In U.S. Patent No. U.S. Pat. No. 11,115,646, the system subject to the invention, in certain embodiments, can detect a number of objects captured on the overlapping area between a computer system, a first field of view associated with the first camera, and a second field of view associated with a second camera. The system can set a corresponding priority order for each of the objects. The system can select an object from the objects according to the corresponding priority order for the object. The system may determine a first illumination condition for the first camera associated with the first field of view. The system can determine a second illumination condition for the second camera associated with the second field of view. The system can determine a shared exposure time for the selected object based on the first illumination condition and the second illumination condition. The system can cause at least one image of the selected object to be captured using the shared exposure time.

U.S. Patent No. U.S. Pat. No. 11,094,043 describes devices, systems and methods for generating high dynamic range images and video from a series of low dynamic range images and video using convolutional neural networks (CNNs). An exemplary method for generating high dynamic range visual media comprises using the first CNN to combine the first set of images with the first dynamic range to generate a final image with a second dynamic range greater than the first dynamic range. Another exemplary method for generating training data comprises generating static and dynamic image sets with the first dynamic range, and generating a real image set with a second dynamic range greater than the first based on the weighted sum of the static image set. It is related to dynamic range and replacing at least one of the dynamic image sets with an image from the static image set to generate a set of training images.

### SUMMARY

LDR cameras are used to a large extent in autonomous vehicles in the state of the art, and for this reason, it is not possible to distinguish and recognize objects in images in scenes with high illumination difference (tunnels, sunrise or sunset, etc.).

The fact that High Dynamic Range (HDR) sensors and cameras are expensive for consumers requires that the same quality images be obtained with economical LDR (Low Dynamic Range) cameras.

Our invention relates to a high-performance object detection system using HDR images obtained from LDR cameras, which allows for the separation and recognition of objects in images under high illumination difference conditions (tunnels, sunrise or sunset, etc.) and prevents autonomous vehicles from causing undesired accidents. The invention tries to eliminate this fundamental problem.

### BRIEF DESCRIPTION OF THE DRAWINGS

FIG. 1 is a General system block diagram;

FIG. 2 is a Detailed system diagram with sub-blocks; and

FIG. 3 is a Block diagram of the jointly trained system for object detection from HDR images.

### DETAILED DESCRIPTION OF THE INVENTION

The reference characters used in the FIGS. are as follows:
4. First Camera
5. Second Camera
6. Third Camera
100. General system block diagram
200. Detailed system diagram with sub-blocks
300. Block diagram of a jointly trained system for object detection from HDR images.

Our invention presents an integrated solution for automatically finding people, vehicles and objects that cannot be detected by the eye as a result of dark areas or high glare in the scene by receiving input from autonomous vehicles through economic cameras.

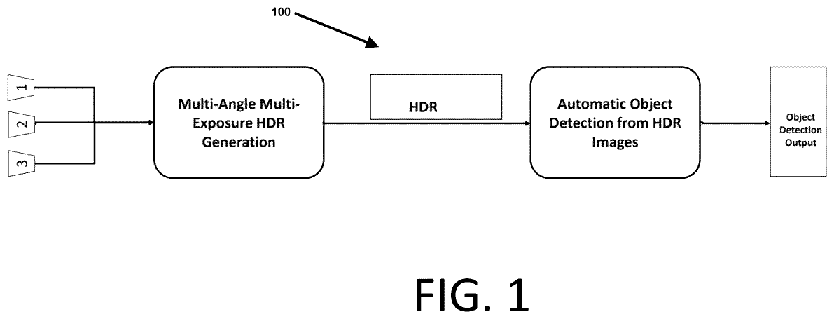

The main flow chart of the system (100) is shown in FIG. 1. For this purpose, at least 3 standard (LDR) cameras, preferably two on the sides and one in the middle, are combined with smart techniques to generate a high dynamic range (HDR) image, and this HDR image is converted to improve automatic detection performance and given as input to automatic object detection algorithms.

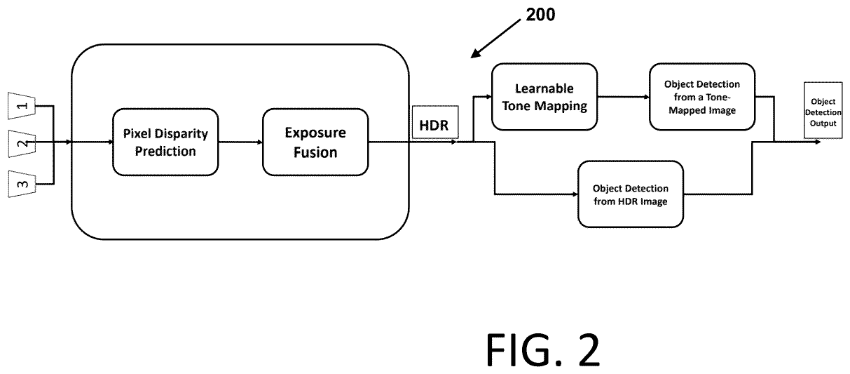

The details of the main block diagram shown in FIG. 1 are explained in FIG. 2 in detail with the system diagram shown with sub-blocks (200). In this diagram, first of all, 3 standard (LDR) cameras are operated with different camera exposure values, and it is aimed for the cameras to better separate the details in the dark or very bright areas of the scene. In order for the right (3) and left cameras (1) (located on the sides) to combine the details, which they have determined, on the middle camera, the disparity values of the image pixels of these cameras at different locations must be predicted for all points in the scene.

The exposure fusion block in FIG. 2 covers the steps taken during the transfer of the pixel values of the two cameras (1,3) located on the sides, which were able to record the difficult-to-see points in the scene in such a way that the details can be noticed due to the appropriate exposure values, to the camera pixels in the middle to generate an HDR image. At this point, after gamma correction, the 3 images normalized according to their exposure times are combined by weighting on the middle camera (2), taking into account the disparity values, and an HDR image is created. While generating the HDR image, the usable pixels from the middle camera (2) are detected and they provide direct input to the HDR image. On the other hand, the unusable pixels (too dark/bright) are weighted and combined with pixels from the left (1) and right camera (3). Thus, stereo mapping defects are prevented from occurring in areas that are not needed.

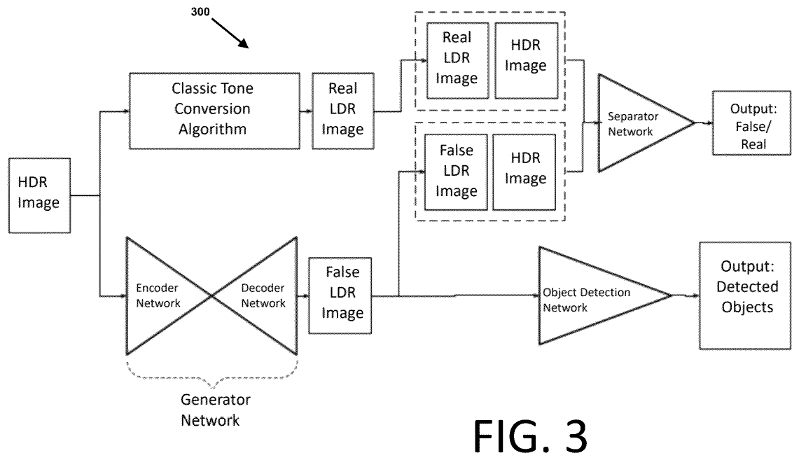

FIG. 3 shows the block diagram of the end-to-end jointly trained system for detecting objects from HDR images (300). The HDR image obtained by combining 3 standard cameras with different exposure values in the previous step will be used to improve automatic object detection. At this point, the related system can work with two different approaches: The obtained HDR images can be given as raw input to the object detection algorithms trained with similarly labeled HDR data. Another solution is to receive the help of a tone mapping algorithm that automatically extracts detail-rich information from HDR data. At this point, tone mapping and object detection sub-blocks are trained end-to-end together in a unique way to increase performance.

### REFERENCES

[1]. A. Aydin Alatan, Y Yemez, X Zabulis, K Muller, C Weigel, A Smolic, “Scene representation technologies for 3DTV—A Survey”, IEEE Transactions on Circuits and Systems for Video Technology 17 (11), 1587-1595, 2007
[2]. E Gündoğdu and A Aydin Alatan, “Good features to correlate for visual tracking”, IEEE Transactions on Image Processing 27 (5), 2526-2540, 2018.
[3]. K. Oksuz, B. C. Cam, S. Kalkan*, E. Akbas*, “Imbalance Problems in Object Detection: A Review”, IEEE Transactions on Pattern Analysis and Machine Intelligence (PAMI), 10.1109/TPAMI.2020.2981890, 2020.
[4]. K. Oksuz, B. C. Cam, E. Akbas*, S. Kalkan*, “A Ranking-based, Balanced Loss Function Unifying Classification and Localisation in Object Detection”, Thirty-fourth Conference on Neural Information Processing Systems (NeurIPS), 2020.
[5]. Cevahir Cigla and A. Aydin Alatan, “Information Permeability for Stereo Matching”, Signal Processing: Image Communication, 28 (9): 1072-1088, 2013.
[6]. M. Yaman, S. Kalkan, “Performance Evaluation of similarity measures for dense multimodal stereo vision”, J. Electron. Imaging 25 (3), 033013, 2016.
[7]. M. Yaman, S. Kalkan, “An Iterative Adaptive Multi-modal Stereo-vision Method using Mutual Information”, Journal of Visual Communication and Image Representation, 26 (0): 115-131, 2015
[8]. A. O. Akyuz, O. T. Tursun, J. H. Telalovic, K. K. Hadziabdic. Ghosting in HDR Video. In High Dynamic Range Video: Concepts, Technologies, and Applications, Academic Press, 2016.ISBN: 9780128094778
[9]. A. Artusi, T. Pouli, F. Banterle, A. O. Akyuz. Automatic saturation correction for dynamic range management algorithms. Signal Processing: Image Communication, 63 (April): 100 {112,2018. DOI: 10.1016/j.image.2018.01.011
[10]. E. Sikudova, T.Pouli, A. Artusi, A. O. Akyuz, F. Banterle, Z. M. Mazlumoglu, and E. Reinhard. A, Gamut Mapping Framework for Color-Accurate Reproduction of HDR Images. IEEE Computer Graphics and Applications, 36 (4): 78 {90,2016. DOI: 10.1109/MCG.2015.116.
[11]. A. O. Akyuz and A. Genctav, A Reality Check for Radiometric Camera Response Recovery Algorithms. Elsevier Computers&Graphics, 37 (7): 935 {943,2013. DOI: 10.1016/j.cag.2013.06.003.
[12]. Alper Koz and Frederic Dufaux, “Methods for Improving the Tone Mapping for Backward Compatible High Dynamic Range Image and Video Compression”, Elsevier Signal Processing: Image Communication, vol. 29, no. 2, pp. 274-292, February 2014.

What is claimed is:

1. A high-performance automatic object detection system using High Dynamic Range (HDR) images obtained from Low Dynamic Range (LDR) cameras, comprising the following steps:
operating first, second, and third LDR cameras with different exposure values and located in different positions;
recording all image points that are difficult to see due to differences in illumination in the scene to be captured, with variable duration exposure values so that details can be noticed, by the first and third LDR cameras
making images recorded by the first and third LDR cameras combinable after gamma correction by equalizing them according to their exposure times,
combining the images recorded according to the exposure times and normalized and made combinable according to the exposure times to generate an HDR image as an HDR image on the second camera by taking into account the pixel disparity values of the cameras at different locations and saving this image as an input to the object detection algorithm,
saving images, which are the outputs of the tone mapping step, using HDR images as input and trained together with the object detection algorithm, as input to the object detection algorithm and automatically detecting objects.

2. A high-performance object detection system using HDR images obtained from LDR cameras as defined in claim 1, wherein the usable pixels from the second camera are detected while generating the HDR image and saved as direct input to generate an HDR image.

3. A high-performance object detection system using HDR images obtained from LDR cameras as defined in claim 1, wherein the unusable pixels from the second camera are combined with the pixels from the first and third cameras by weighting while generating the HDR image.

4. A high-performance object detection system using HDR images obtained from LDR cameras as defined in claim 1, wherein the tone mapping block that transmits images to the automatic detection unit is selected as a learnable algorithm and the automatic detection and tone mapping blocks are trained together.

5. A high-performance object detection system using HDR images obtained from LDR cameras as defined in any one of the above claims, wherein the first and third cameras are positioned on the sides and the second camera is positioned in the middle.
